(19) United States
(12) Patent Application Publication
(10) Pub. No.: US 2023/0206927 A1
(43) Pub. Date: Jun. 29, 2023

(54) SYSTEM FOR IDENTIFYING A SPEAKER

(71) Applicant: RENAULT S.A.S, Boulogne-Billancourt (FR)

(72) Inventor: Norbert ROSSELLO, Biot (FR)

(73) Assignee: RENAULT S.A.S, Boulogne-Billancourt (FR)

(21) Appl. No.: 18/000,250

(22) PCT Filed: Mar. 2, 2021
(86) PCT No.: PCT/EP2021/055164

§ 371 Date: Dec. 23, 2022

(30) Foreign Application Priority Data
May 29, 2020 (FR) 2005690

(51) Int. Cl. G10L 17/06; G10L 25/51

(52) U.S. Cl. CPC G10L 17/06; G10L 25/51

(57) ABSTRACT

A method identifies a particular speaker from among a set of speakers via a computer that includes a computer memory in which voice signatures, each associated with one of the speakers in the set, are stored. The method includes acquiring a voice signal produced by the particular speaker, constructing a new voice signature in accordance with the voice signal, comparing the new voice signature with at least one of the voice signatures stored in the computer memory, and identifying the particular speaker in accordance with the result of the comparison. The method also includes, before the constructing, generating a complete signal that includes the voice signal and at least one predetermined extension signal. Accordingly, the constructing also includes, constructing the new voice signature in accordance also with each extension signal.

The present invention generally relates to the field of identifying people on the basis of their voices.

It is particularly advantageously applicable to identifying a user of a motor vehicle.

It relates more particularly to a method for identifying a particular speaker from among a set of speakers, by means of a computer which comprises a computer memory in which at least one reference voice signature associated with one of the speakers in said set is recorded, the method comprising steps of:
acquiring an identifying voice signal produced by the particular speaker,
constructing an identifying voice signature in accordance with said identifying voice signal,
comparing said identifying voice signature with the at least one reference voice signature recorded in the computer memory, and
identifying the particular speaker in accordance with the result of said comparison.

It also relates to a method for recording a new speaker in the memory of the computer.

Finally, it relates to a motor vehicle comprising the technical means required to implement one and/or other of these two methods.

It is known practice to use wake-up phrases to make an electronic device leave standby in order to then be able to control a particular function. One example of a wake-up phrase is “Hello Google”. This phrase makes it possible to make an Android® device leave standby in order for it to then be able to perform a particular action (search for an answer to a question, switch on a light, etc.).

These wake-up phrases are chosen so as to be particularly short, so as to be quick for the speaker to pronounce.

One of the difficulties is that the speaker tends to pronounce this phrase quickly and sometimes in a truncated fashion. There are then found to be difficulties in detecting this phrase using the device. Consequently, it is understood that it will not be possible to identify the speaker reliably on the basis of this wake-up phrase alone.

Now, particularly in the automotive field, there is a desire to be able to identify the passengers who produce voice commands in order, for example, to ensure whether or not they are authorized to produce these commands. By way of example, there is a desire to be able to ensure that the passenger who orders their window to be opened fully is authorized to do so.

One solution known in the field of voice biometrics for identifying a person consists in asking them to produce a longer phrase, such as “My voice is the password”. By virtue of the length of this phrase, it then proves possible to identify the speaker from among the various speakers who have been recorded in the system.

The drawback of these phrases is that, because of their great length, they prove too tiresome to pronounce to be employed regularly.

In order to remedy the aforementioned drawback of the prior art, the present invention proposes using short phrases and then enriching them computationally and invisibly to users, in order to be able to highly reliably identify any person who produces a phrase. More particularly, according to the invention an identification method as defined in the introduction is proposed, in which provision is made, upstream, for at least one reference voice signature recorded in the computer memory to have been determined in accordance with a recorded voice signal and with a predetermined extension signal, and in which provision is made, before the construction step, for a step of generating a complete signal which comprises said identifying voice signal and said predetermined extension signal, and in which, in the construction step, the identifying voice signature is constructed in accordance also with said extension signal.

The recorded voice signal makes it possible for the speaker to be recorded on the computer application. This signal is mixed with an extension signal and is then processed in order to deduce a recorded voice signature therefrom.

During the identification method, the speaker produces an identifying voice signal again, which is mixed with the same extension signal and is then processed in order to deduce an identifying voice signature therefrom.

This identifying voice signature will then be compared with all the recorded voice signatures recorded in the memory of the application, so as to be able to find who the speaker is.

Thus, voice signatures enriched by virtue of the extension signal are compared.

In other words, by virtue of the invention, the voice signal used may be a short phrase insofar as it is then lengthened by means of the extension signal, this making it possible to make a longer phrase out of it, ensuring better recognition of the speaker from among the speakers recorded in the system.

One advantage of this solution is that it is painless for the user, as the latter proceeds as before, being content with uttering a short phrase.

Another advantage of this solution is that it makes it possible to ensure better computer security.

Specifically, if a hacker manages to procure a record of the voice of a recorded user, they will not be able to do anything with it as they do not know the extension signals which would have to be added to the voice signal in order to make a success of the identification.

Yet another advantage is that this solution ensures better robustness against external parasitic noise, as the extension signals added are not noisy and therefore lower the overall noise level of the complete signal serving for identification.

Other advantageous and non-limiting features of the identification method in accordance with the invention, taken individually or in any technically feasible combination, are the following:
the computer memory comprises a plurality of reference voice signatures which are associated, respectively, with a plurality of speakers in said set, the extension signal being associated with one of the speakers and being different from the extension signals associated with the other speakers, said memory storing each extension signal so as to be associated with one of the speakers;
in the generation step, the computer generates at least as many complete signals as there are speakers in said set, each complete signal comprising said identifying voice signal and one of said extension signals recorded in said memory;
in the construction step, the computer constructs an identifying voice signature for each complete signal;
in the comparison step, the computer compares each identifying voice signature with each reference voice signature recorded in the memory in order to deduce a score therefrom;
in the identification step, the particular speaker is identified taking into account the deduced scores;
the complete signal is constructed by affixing the extension signal before and/or after said identifying voice signal;
the extension signal is a function of a sum of at least one sinusoid with a frequency of between 50 and 650 Hz, and preferably between 100 and 500 Hz;
the extension signal results from the product of a parameterizable function and of an observation window function, said parameterizable function preferably being amplitude- and/or frequency-modulated;
the maximum amplitude of the extension signal is less than or equal to the maximum amplitude of the identifying voice signal, and is preferably less than or equal to 80% of the maximum amplitude of the identifying voice signal;
the maximum length of said at least one extension signal is less than or equal to a third of the total length of the complete signal, and is preferably equal to 20% of the total length of the complete signal;
the identifying voice signal comprises a number of syllables which is less than or equal to four.

The invention also bears on a method for recording a particular speaker by means of a computer which comprises a computer memory, the method comprising steps of:
acquiring a recorded voice signal produced by the particular speaker,
determining an extension signal,
generating a recorded complete signal which comprises said recorded voice signal and the extension signal,
determining a reference voice signature in accordance with the recorded complete signal, and
storing said reference voice signature in said memory so as to be associated with the particular speaker.

The invention also relates to a motor vehicle comprising a passenger compartment, means for acquiring a voice signal produced by a particular speaker who is located in the passenger compartment, and a computing unit which is programmed to implement one and/or other of the aforementioned methods.

Of course, the various features, variants and embodiments of the invention may be associated with one another in various combinations insofar as they are not mutually exclusive or incompatible.

The description which follows, with reference to the appended drawings, which are given by way of non-limiting examples, will make it quite clear what the invention consists in and how it may be embodied.

In the appended drawings:

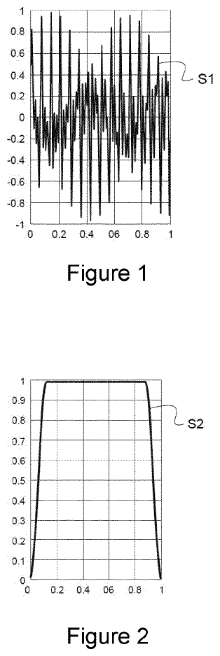

FIG. 1 is a graph illustrating a parameterizable function which may be used in the context of a method in accordance with the invention;

FIG. 2 is a graph illustrating an observation window function which may be used in the context of the method in accordance with the invention;

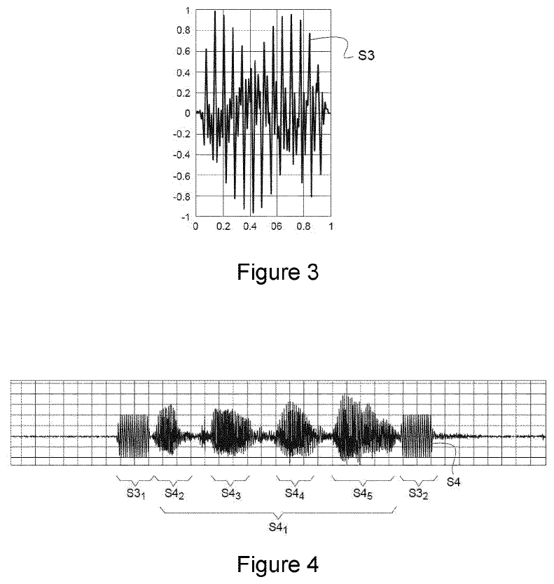

FIG. 3 is a graph illustrating an extension function which may be used in the context of the method in accordance with the invention;

FIG. 4 is a graph illustrating a complete signal comprising the extension function of FIG. 3;

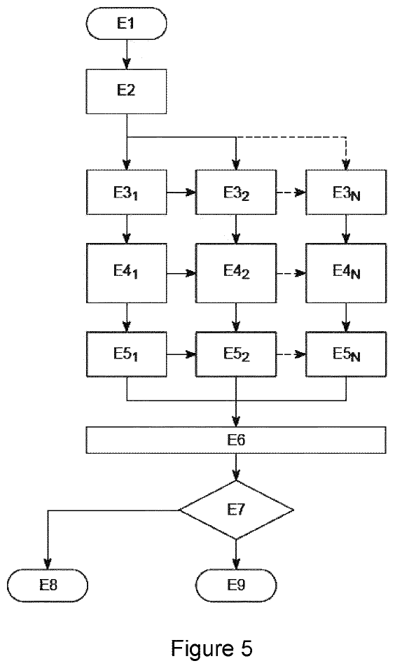

FIG. 5 is a diagram illustrating one implementation of an identification method in accordance with the invention.

The invention may be implemented on any type of device. In the example which will be described here, it will be implemented in a motor vehicle, and more specifically in a car which may accommodate several users (a driver and passengers).

This motor vehicle will be in a conventional form.

It thus comprises a chassis which delimits a passenger compartment for the users.

It also comprises voice signal acquisition means. These acquisition means are, for example, in the form of microphones arranged in the motor vehicle so as to be able to record the phrases produced by the various passengers of the motor vehicle.

The motor vehicle also comprises a computer which is connected to the microphones, and which forms an information processing system programmed in a particular way in order to implement the invention.

The computer more specifically comprises at least one processor, one memory, various input and output interfaces, as well as a human-machine interface.

By virtue of its memory, the computer stores a computer application, consisting of computer programs comprising instructions, the execution of which by the processor makes it possible for the methods described below to be implemented by the computer.

By virtue of its input interfaces, the computer can read the data acquired by the microphones.

By virtue of its output interfaces, the computer can order certain functions of the motor vehicle to be implemented such as, for example, opening the windows or starting the engine.

The Human-Machine interface may be in various forms. It will here be considered to have a touch screen and speakers located in the passenger compartment of the vehicle.

As will indeed be described in the rest of this disclosure, the invention mainly relates to identifying a speaker on the basis of a phrase produced vocally by the latter.

What is meant here by “phrase” is a group of words forming a set phrase. In practice, this means predefined key words.

In the example which will be considered, the speaker will be the driver of the vehicle, but could as a variant be any other passenger.

According to the present invention, identifying the speaker is possible only if the latter has been recorded beforehand on the information processing system.

The process for identifying the speaker consists, specifically, in determining, from among a set of users of the vehicle who have been recorded beforehand, which one is producing the phrase.

In a first part of this disclosure, the way in which the driver may be recorded on the system will therefore be described. The second part of the disclosure will for its part bear on the identification of the driver itself.

The recording procedure is carried out in several successive steps. It aims to make it possible to generate a voice signature associated with the speaker. The first step here consists, for the driver, in initiating the procedure by selecting a corresponding menu in the computer application, by means of the touch screen.

Once the procedure has been initiated, the computer generates a request by means of the Human-Machine interface, which consists in asking the driver to pronounce or even, preferably, to repeat the same predetermined phrase several times.

This phrase is preferably chosen when the computer application is being designed so as to meet two criteria.

The first criterion is a comprehension criterion.

In order for the computer to be able to detect every moment when the driver pronounces this phrase, the latter must be voiced. In other words, it must comprise low-frequency tones. It will therefore be chosen so that it comprises as many vowels as possible.

The second criterion is a time criterion.

The phrase must specifically be quick to utter so that the driver may say it easily and quickly, without this becoming tiresome for them. This criterion is satisfied when the phrase comprises three or four syllables. In this way, the phrase may be uttered in a period of less than a second.

The phrase chosen here is “Hello Renault”.

During the recording procedure, the computer records a long voice signal, which is then cut up into three voice signals corresponding to the three moments when the phrase was uttered. These three voice signals are then combined into a single recorded voice signal S4₁, which is considered to form a characteristic example of an utterance of the phrase by the driver.

The computer may deduce a base voice signature from this recorded voice signal S4₁, by using a conventional processing process well-known to a person skilled in the art, which will hereinafter be called the “acoustic fingerprint generation process”.

This process may be described succinctly in the following way.

It first of all comprises an acoustic analysis which consists in extracting relevant and characteristic information from the recorded voice signal. For this purpose, sets of acoustic coefficients are computed at regular time intervals (that is to say, for successive observation windows), over fixed-length signal blocks. These sets of coefficients together compose an acoustic matrix which forms a digital signature which is characteristic of the voice of the driver.

Each set of coefficients is, for example, computed using Discrete Cosine transforms of the logarithm of the energy spectral density of the signal. The cepstral coefficients resulting from such an analysis do indeed specifically characterize the shape of the spectrum.

In this instance, the cepstral coefficients used are MFCCs (Mel-Frequency Cepstral Coefficients). They specifically have the advantage of being weakly correlated with one another.

The process is, furthermore, completed here by Mel filter bank filtering, this making it possible to emphasize the richness of the voiced sounds.

The acoustic fingerprint generation process thus makes it possible to generate, in accordance with the recorded voice signal S4₁, a base voice signature which is characteristic of the voice of the driver.

Once this base voice signature has been obtained, according to the invention, the computer will seek to compute another voice signature, referred to as the extended voice signature.

The idea is that the phrase “Hello Renault” alone is too short to make it possible to identify the speaker robustly from among several recorded users using only their base voice signature. This is notably the case when the driver is affected by a particular pathological state (illness, emotion, fatigue, etc.), when the sound recording conditions are not good (ambient noise, etc.), or when the driver has pronounced the phrase incomprehensibly (truncated word, etc.).

In order to obtain the extended voice signature, the computer first of all determines an extension signal. This extension signal is intended to be affixed to the recorded voice signal, in order to lengthen it, so as to be able to obtain a complete signal which will be able to be processed by means of the acoustic fingerprint generation process in order to generate the extended voice signature.

The extension signal is associated with the driver. It is therefore chosen so as to be different from the extension signals already used for the other speakers recorded in the system.

This extension signal results from a parameterizable function S1(t), one example of which is illustrated in FIG. 1.

This parameterizable function S1(t) is preferably a sum of at least one sinusoid at a frequency of between 100 and 500 Hz.

In the embodiment described here, this parameterizable function S1(t) is expressed in the following form:

$$S 1 ( t ) = {\sum }_{i = 1}^{M} {A}_{i} \cdot sin ( 2 \cdot π \cdot {f}_{i} \cdot t + {φ}_{i} )$$

In this equation, the adjustable parameters are:
M: the number of sinusoids,
Aᵢ: the amplitude of each sinusoid,
fᵢ: the frequency of each sinusoid, and
ϕᵢ: the phase of each sinusoid.

This function is preferably amplitude-modulated (Aᵢ then being a function of time t) and/or frequency-modulated (fᵢ then being a function of time t).

The set of parameters which are chosen to create the extension signal is selected so that the extension signals associated with the various speakers are quite distinct from one another.

It may be considered that two extension signals are distinct from one another in frequency when at least one step of 20 Hz separates each of the two frequencies.

It may be considered that two extension signals are distinct from one another in phase when at least one step of π/4 radians separates each of the two phases. The amplitudes may be considered to be close to unity in order to maximize the presence of the extension signal in frequency (energy) terms.

These sets of parameters may be chosen randomly by the computer, in which case the latter will then check that they do indeed fulfill the aforementioned distinctness conditions.

As a variant, sets of parameters may be predetermined and recorded in the memory of the computer, in which case the computer will be able, each time a new speaker is recorded, to go and search in its memory for a new set of parameters which has not yet been used.

In the example illustrated in FIG. 1, the following set of parameters was used:

### M=3

(A₁, f₁, ϕ₁)=(1, 127, 0)
(A₂, f₂, ϕ₂)=(1, 241, 0)
(A₃, f₃, ϕ₃)=(1, 353, 0)

The parameterizable function S1(t) obtained is then modified so that, once affixed to the recorded voice signal S4₁, no discontinuity appears at the junction between the curves.

For this purpose, provision is made for computing the product of this parameterizable function S1(t) and of a predetermined observation window function (S2(t)) which is illustrated in FIG. 2.

The observation window function (S2(t)) here is an apodization function. It makes it possible to ensure that the product of the parameterizable function S1(t) and of the observation window function (S2(t)) takes the zero value at the start and at the end of the time window under consideration.

In the example described here, the equation of the observation window function (S2(t)) is the following.

$$S 2 ( t ) = \{ \begin{matrix}\frac{1}{2} \cdot ( 1 + cos ( \frac{2 \cdot π}{r} \cdot ( x - \frac{r}{2} ) ) & if x ∈ [ 0 ; \frac{r}{2} [ \\ 1 & if x ∈ [ \frac{r}{2} ; 1 - \frac{r}{2} [ \\ \frac{1}{2} \cdot ( 1 + cos ( \frac{2 \cdot π}{r} \cdot ( x - 1 + \frac{r}{2} ) ) & if x ∈ [ 1 - \frac{r}{2} ; 1 [\end{matrix}$$

In this equation:
x is the time period normalized with respect to the length of the time window under consideration, and
r is a cosine weighting coefficient, here chosen equal to 0.25.

The extension signal S3 is then chosen equal to the product of the parameterizable signal S1 and of this observation window function S2. It is shown in FIG. 3.

At this stage, it will be noted that the extension signal S3 is parameterized so that its maximum amplitude is less than or equal to 80% of the maximum amplitude of the recorded voice signal, and that the total length of the one or more extension signals affixed to the recorded voice signal S4₁ does not exceed 20% of the total length of the complete signal.

This complete signal is then obtained by affixing the extension signal S3 to the start and/or to the end of the recorded voice signal. It is affixed here to the start and to the end of the voice signal.

The complete signal S4 thus obtained is shown in FIG. 4. It may be observed therein that it comprises two identical signals S3₁, S3₂ which frame the recorded voice signal S4₁, and which correspond to the extension signal S3.

It may also be observed therein that the recorded voice signal S4₁ comprises four parts S4₂, S4₃, S4₄ and S4₅, which correspond to the four syllables of the phrase “Hello Renault”.

At this stage, the complete signal S4 is processed by means of the acoustic fingerprint generation process, so as to obtain the extended voice signature.

This extended voice signature, the base voice signature and the extension signal S3 which is used are then stored in the computer memory of the computer, so as to be associated with the driver.

This association may take various forms.

Thus, these various elements may simply be stored in a record which stores access rights of the driver (the right to open the windows, the right to ask for the engine to be started, etc.).

Here, it will be considered rather that the base voice signature, the extended voice signature and the extension signal S3 are recorded in three fields of a record of a database. This record further comprises a fourth field, which stores the name of the driver (entered beforehand on the touch screen) and a fifth field, which stores the access rights of the driver (chosen by the latter from a menu displayed on the touch screen). Any other variant may also be envisaged. In any event, at the end of several successive recording procedures, the computer stores a closed set of N triplets of voice signatures (each triplet comprising a base voice signature, an extended voice signature associated with one of the N recorded speakers and an associated extension signal S3). An extended voice signature stored in the computer memory at the end of a recording procedure is referred to as a reference voice signature. A base voice signature stored in the computer memory at the end of a recording procedure is referred to as a reference voice signature.

Alternatively, with the aim of gaining space in the computer memory of the computer, it is possible to store a base voice signature and parameters making it possible to reconstruct an extended voice signature.

It may now be described how the method for identifying the driver is implemented.

For this purpose, two different embodiments may be described.

The first embodiment is illustrated in FIG. 5.

When the doors of the motor vehicle are unlocked, the computer is supplied with current, and it enters a standby state (step E1). In this state, it is content to process the data received from the microphones.

Thus, over a step E2 of initiating the identification method, the driver orally articulates the agreed phrase (here “Hello Renault”), and the computer can detect this phrase. It then records in its memory the new voice signal captured by the microphones and containing this phrase. This new voice signal is an identifying voice signal.

The length of this new voice signal is adjusted to the time it takes to articulate the phrase.

Over a step E3₁, the computer affixes the new voice signal to the first of the N extension signals recorded in its memory, namely the one which is associated with the first speaker who was recorded, and which is stored in the first record of its database. This operation is performed in the same way as during the recording procedure, here by affixing the extension signal before and after the new voice signal.

Then, over a step E4₁, the computer determines a new extended voice signature. This new extended voice signature is an identifying voice signature. It is for this purpose based on the complete signal obtained in step E3₁, by applying the acoustic fingerprint generation process to it.

Finally, over a step E5₁, the computer compares this extended voice signature with the extended voice signature which is stored in the first record of its database. In other words, the computer compares the identifying voice signature with the reference voice signature.

This comparison step is performed in a way known per se, by comparing the sets of acoustic coefficients of these two signatures. This comparison makes it possible to determine a score, which is higher here the closer the sets of acoustic coefficients of these two signatures are.

These three steps E3₁, E4₁ and E5₁ are here repeated N times (see the steps E3₂ . . . E3_{N}, E4₂ . . . E4_{N} and E5₂ . . . E5_{N} in FIG. 5), utilizing the data stored in the N records of the database which are associated with the N recorded speakers.

The computer thus obtains as many scores as there are speakers recorded in its memory.

Once these scores have been computed, over a step E6, the computer compares all of these scores and selects the highest. This maximum score is associated with one of the recorded speakers, hereinafter called the selected speaker.

At this stage, the computer might conclude that the driver corresponds to the selected speaker.

However, for more security, over a step E7, the computer compares this maximum score with a predetermined threshold.

If this maximum score is below the predetermined threshold, over a step E8, the computer displays on the touch screen or transmits to the speakers a message signifying to the driver that they have not been recognized. Specifically, this score is considered to be insufficient to recognize with sufficient reliability whether the selected speaker does indeed correspond to the driver. In this eventuality, it is proposed to the driver either to be recorded, or to rearticulate the phrase.

In the opposite case, over a step E9, the computer considers that the maximum score is sufficiently high to consider with sufficient reliability that the selected speaker does indeed correspond to the driver. In this eventuality, the driver is indeed recognized.

They may then produce instructions, such as the order to open the windows or to start the engine. These instructions will then be followed on the condition that the access rights of the driver allow this.

The second embodiment of the identification method may now be described.

In this second embodiment, the steps E1 and E2 are identical to those mentioned above and described with reference to FIG. 5.

At the end of the step E2, provision is, however, made for the computer to proceed to compute a base voice signature, taking into account the new voice signal which has just been produced by the driver. This base voice signature is an identifying base voice signature. Then the computer compares this identifying base voice signature with each of the reference base voice signatures recorded in the memory of the computer. It proceeds, for this purpose, in the same way as mentioned above, this making it possible for it to obtain N scores.

Then, if the maximum score obtained is above a first predetermined threshold, the computer may consider that the driver has been recognized (step E9).

In contrast, if the maximum score is below a second predetermined threshold, the computer may consider that the driver has not been recognized and that they will not be able to be recognized (step E8).

If the maximum score is between these two thresholds, the computer may attempt to recognize the driver by then proceeding as in the first embodiment, no longer based on the base voice signals but rather on the extended voice signals. For this purpose, it may implement the step E3₁ and following steps of the first embodiment described.

The present invention is in no way limited to the embodiments described and shown, but a person skilled in the art will be able to add any variant in accordance with the invention.

In particular, provision may be made for the signature associated with a speaker to be formed not by a set of acoustic coefficients, as has been described above, but by any other element. By way of example, the voice signature of a speaker may be formed by the recorded voice signal itself (by the raw signal or by a signal which has possibly been reworked, for example in order to remove parasitic noise).

As another variant, the extension signal may not be affixed directly to the start or to the end of the voice signal recorded by the microphones, but provision may be made for leaving an empty time interval between the extension signal and the voice signal. It will be noted that, preferably, these two signals will not overlap, in whole or part, as the consequence of this would be to reduce the reliability of the results.

As another variant, the extension signals used for the various speakers recorded in the database might be the same, but the consequence of this here would be to further reduce the reliability of the results.

1-10. (canceled)

11. A method for identifying a particular speaker from among a set of speakers, via a computer which comprises a computer memory in which at least one reference voice signature associated with one of the speakers in said set is recorded, the method comprising:
acquiring an identifying voice signal produced by the particular speaker,
constructing an identifying voice signature in accordance with said identifying voice signal,
comparing said identifying voice signature with the at least one reference voice signature recorded in the computer memory, and
identifying the particular speaker in accordance with the result of said comparison,
wherein the at least one reference voice signature recorded in the computer memory was determined in accordance with a recorded voice signal and with a predetermined extension signal,
wherein provision is made, before the constructing, for generating a complete signal which comprises said identifying voice signal and said predetermined extension signal, and
wherein, in the constructing, the identifying voice signature is constructed in accordance also with said extension signal.

12. The identification method as claimed in claim 11, wherein the computer memory comprises a plurality of reference voice signatures which are associated, respectively, with a plurality of speakers in said set, the extension signal being associated with one of the speakers and being different from the extension signals associated with the other speakers, said memory storing each extension signal so as to be associated with one of the speakers.

13. The identification method as claimed in claim 12, wherein:
in the generating, the computer generates at least as many complete signals as there are speakers in said set, each complete signal comprising said identifying voice signal and one of said extension signals recorded in said memory,
in the constructing, the computer constructs an identifying voice signature for each complete signal,
in the comparing, the computer compares each identifying voice signature with each reference voice signature recorded in the memory in order to deduce a score therefrom, and
in the identifying, the particular speaker is identified taking into account the deduced scores.

14. The identification method as claimed in claim 11, wherein the complete signal is constructed by affixing the extension signal before and/or after said identifying voice signal.

15. The identification method as claimed in claim 11, wherein the extension signal is a function of a sum of at least one sinusoid with a frequency of between 50 and 650 Hz.

16. The identification method as claimed in claim 11, wherein the extension signal is a function of a sum of at least one sinusoid with a frequency of between 100 and 500 Hz.

17. The identification method as claimed in claim 11, wherein the extension signal results from the product of a parameterizable function and of an observation window function, said parameterizable function preferably being amplitude- and/or frequency-modulated.

18. The identification method as claimed in claim 11, wherein:
the maximum amplitude of the extension signal is less than or equal to the maximum amplitude of the identifying voice signal, and/or
the maximum length of said at least one extension signal is less than or equal to a third of the total length of the complete signal.

19. The identification method as claimed in claim 11, wherein:
the maximum amplitude of the extension signal is less than or equal to 80% of the maximum amplitude of the identifying voice signal, and/or
the maximum length of said at least one extension signal is equal to 20% of the total length of the complete signal.

20. The identification method as claimed in claim 11, wherein the identifying voice signal comprises a number of syllables which is less than or equal to four.

21. A method for recording a particular speaker via a computer which comprises a computer memory, the method comprising:
acquiring a recorded voice signal produced by the particular speaker,
determining an extension signal,
generating a recorded complete signal which comprises said recorded voice signal and the extension signal,
determining a reference voice signature in accordance with the recorded complete signal, and
storing said reference voice signature in said memory so as to be associated with the particular speaker.

22. A motor vehicle comprising:
a passenger compartment,
means for acquiring a voice signal produced by a particular speaker who is located in the passenger compartment, and
a computing unit which is programmed to implement identification method as claimed in claim 11.
